(19) United States
(12) Patent Application Publication
(10) Pub. No.: US 2010/0166628 A1
(43) Pub. Date: Jul. 1, 2010

(54) CATALYST FOR REDUCING NITROGEN-CONTAINING POLLUTANTS FROM THE EXHAUST GASES OF DIESEL ENGINES

(76) Inventors: Nicola Soeger, Franfurt am Main (DE); Wolfgang Schneider, Rodenbach (DE); Yvonne Demel, Frankfurt (DE); Lothar Mussmann, Offenbach (DE); Ralf Sesselmann, Ranstadt (DE); Thomas Kreuzer, Karben (DE)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/301,752

(22) PCT Filed: Feb. 15, 2007
(86) PCT No.: PCT/EP07/03922

§ 371 Date: May 21, 2009

(30) Foreign Application Priority Data
Feb. 15, 2006 (US) 11354433

(51) Int. Cl. B01D 53/54; B01J 29/88; B01J 29/072; B01D 50/00

(52) U.S. Cl. 423/213.5; 502/74; 502/66; 422/171

(57) ABSTRACT

In exhaust gas purification units for decreasing nitrogen oxides in lean-burn exhaust gas of internal combustion engines by selective catalytic reduction by means of ammonia, introduction of excess ammonia leads to undesirable emissions of unused ammonia. These emissions can be decreased by means of ammonia barrier catalysts. In the ideal case, ammonia is oxidized to nitrogen and water by these catalysts. These require additional space in the exhaust gas purification unit which may have to be taken away from the space provided for the SCR main catalyst. In addition, the use of such ammonia barrier catalysts can result in overoxidation of the ammonia to nitrogen oxides.

To overcome these disadvantages, a catalyst containing two superposed layers is proposed for the removal of nitrogen-containing pollutant gases from diesel exhaust gas. The lower layer contains an oxidation catalyst and the upper layer can store at least 20 milliliters of ammonia per gram of catalyst material. This catalyst displays reduced ammonia breakthrough at good SCR conversions in the low-temperature range. It can be used as SCR catalyst having reduced ammonia breakthrough or as ammonia barrier catalyst.

The invention relates to the removal of nitrogen-containing pollutant gases from the exhaust gas of internal combustion engines operated using a lean air/fuel mixture (known as “lean-burn engines”), in particular from the exhaust gas of diesel engines.

The emissions present in the exhaust gas of a motor vehicle operated using a lean-burn engine can be divided into two groups. Thus, the term primary emissions refers to pollutant gases which are formed directly by the combustion process of the fuel in the engine and are present in the raw emission before passing through exhaust gas purification devices. Secondary emissions are pollutant gases which can be formed as by-products in the exhaust gas purification units.

The exhaust gas of lean-burn engines comprises the usual primary emissions carbon monoxide CO, hydrocarbons HCs and nitrogen oxides NOx together with a relatively high oxygen content of up to 15% by volume. Carbon monoxide and hydrocarbons can easily be rendered nonharmful by oxidation. However, the reduction of the nitrogen oxides to nitrogen is significantly more difficult because of the high oxygen content.

A known method of removing nitrogen oxides from exhaust gases in the presence of oxygen is the process of selective catalytic reduction (SCR process) by means of ammonia over a suitable catalyst, referred to as SCR catalyst for short.

Here, a distinction is made, depending on the engine concept and structure of the exhaust gas unit, between “active” and “passive” SCR processes, in “passive” SCR processes secondary ammonia emissions generated in a targeted manner in the exhaust gas units are used as reducing agent for removal of nitrogen oxides.

Thus, U.S. Pat. No. 6,345,496 B1 describes a process for purifying engine exhaust gases, in which lean and rich air/fuel ratios are repeatedly set alternately and the exhaust gas produced in this way is passed through an exhaust gas unit containing a catalyst which converts NOₓ into NH₃ only under rich exhaust gas conditions at the inflow end while a further catalyst which adsorbs or stores NOₓ under lean conditions and liberates NOₓ under rich conditions so that it can react with NH₃ produced by the inflow-end catalyst to form nitrogen is located at the outflow end. As an alternative, an NH₃ adsorption and oxidation catalyst which stores NH₃ under rich conditions and desorbs NH₃ under lean conditions and oxidizes it by means of nitrogen oxides or oxygen to form nitrogen and water can be located at the outflow end according to U.S. Pat. No. 6,345,496 B1.

WO 2005/064130 also discloses an exhaust gas unit containing a first catalyst located at the inflow end which produces NH₃ from exhaust gas constituents during the rich phase. In a second, downstream catalyst, NH₃ is stored periodically. The nitrogen oxides present in the exhaust gas in the lean phase are reacted with the stored ammonia. The exhaust gas unit also contains a third noble metal-containing catalyst which contains at least platinum, palladium or rhodium on support materials which are able to store ammonia during the rich phase and desorb it again during the lean phase.

WO 2005/099873 A1 claims a process for removing nitrogen oxides from the exhaust gas of lean-burn engines in cyclic rich/lean operation, which comprises the substeps NOₓ storage in an NOₓ storage component in the lean exhaust gas, in-situ conversion of stored NOₓ into NH₃ in the rich exhaust gas, storage of NH₃ in at least one NH₃ storage component and reaction of NH₃ with NOₓ under lean exhaust gas conditions, with the first and last subreactions proceeding for at least part of the time and/or partly simultaneously and/or in parallel. To carry out the process, an integrated catalyst system comprising at least one NOₓ storage component, an NH₃ generation component, an NH₃ storage component and an SCR component is claimed.

The use of such “passive” SCR processes is restricted to vehicles in which reducing (“rich”) exhaust gas conditions can be generated in the engine without great difficulty. This applies to directly injected petrol engines. Diesel engines, on the other hand, cannot readily be operated using a substoichiometric (“rich”) air/fuel mixture. The generation of reducing exhaust gas conditions has to be effected by means of measures outside the engine, e.g. subsequent injection of fuel into the exhaust gas train. This leads to problems in adhering to HC exhaust gas limits, to exothermic reactions in downstream oxidation catalysts, premature thermal ageing of the latter and not least to a significant increase in fuel consumption. “Active” SCR processes are therefore the focus of development and application for the removal of NOₓ from the exhaust gas of diesel engines.

In “active” SCR processes, the reducing agent is introduced into the exhaust gas train from an accompanying additional tank by means of an injection nozzle. In place of ammonia, a compound which can readily be decomposed into ammonia, for example urea, can be used for this purpose. Ammonia has to be added to the exhaust gas in at least a stoichiometric ratio to the nitrogen oxides.

The conversion of the nitrogen oxides can usually be improved by introduction of a 10-20 percent excess of ammonia, but this drastically increases the risk of higher secondary emissions, in particular by increased ammonia breakthrough. Since ammonia is a gas which has a penetrating odor even in low concentrations, it is in practice an objective to minimize ammonia breakthrough. The molar ratio of ammonia to the nitrogen oxides in the exhaust gas is usually designated by alpha:

$$α = \frac{c ( {NH}_{3} )}{c ( {NO}_{x} )}$$

In internal combustion engines in motor vehicles, the precise metering of ammonia presents great difficulties because of the greatly fluctuating operating conditions of the motor vehicles and sometimes leads to considerable ammonia breakthroughs downstream of the SCR catalyst. To suppress the ammonia breakthrough, an oxidation catalyst is usually arranged downstream of the SCR catalyst in order to oxidize ammonia which breaks through to nitrogen. Such a catalyst will hereinafter be referred to as an ammonia barrier catalyst. The ammonia light-off temperature T₅₀ (NH₃) is reported as a measure of the oxidizing power of the catalyst. It indicates the reaction temperature at which the ammonia conversion in the oxidation reaction is 50%.

Ammonia barrier catalysts which are arranged downstream of an SCR catalyst to oxidize ammonia which breaks through are known in various embodiments. Thus, DE 3929297 C2 (U.S. Pat. No. 5,120,695) describes such a catalyst arrangement. According to this document, the oxidation catalyst is applied as a coating to an outflow-end section of the single-piece reduction catalyst configured as an all-active honeycomb extrudate, with the region coated with the oxidation catalyst making up from 20 to 50% of the total catalyst volume. As catalytically active components, the oxidation catalyst contains at least one of the platinum group metals platinum, palladium and rhodium which are deposited on cerium oxide, zirconium oxide and aluminum oxide as support materials.

According to EP 1 399 246 B1, the platinum group metals can also be applied directly to the components of the reduction catalyst as support materials by impregnation with soluble precursors of the platinum group metals.

According to JP2005-238199, the noble metal-containing layer of an ammonia oxidation catalyst can also be introduced under a coating of titanium oxide, zirconium oxide, silicon oxide or aluminum oxide and a transition metal or a rare earth metal.

The use of ammonia barrier catalysts brings with it, especially when highly active oxidation catalysts are used, the risk of overoxidation to nitrogen oxides. This phenomenon reduces the conversions of nitrogen oxides which can be achieved by means of the overall system of SCR and barrier catalysts. The selectivity of the ammonia barrier catalyst is therefore an important measure of its quality. The selectivity to nitrogen for the purposes of this document is a concentration figure and is calculated from the difference between all measured nitrogen components and the amount of ammonia introduced.

c(N₂)=½·[c_{introduced}(NH₃)−cₒᵤₜₗₑₜ(NH₃)−2cₒᵤₜₗₑₜ(N₂O)−cₒᵤₜₗₑₜ(NO)−cₒᵤₜₗₑₜ(NO₂)]

If an ammonia barrier catalyst is required, space for a further catalyst has to be made available in the exhaust gas purification unit. Here, the ammonia barrier catalyst can be arranged in an additional converter downstream of the converter containing the SCR catalyst. However, such arrangements are not widespread since the space for installation of an additional converter is generally not available in the vehicle.

As an alternative, the ammonia barrier catalyst can be located in the same converter as the SCR catalyst (“integrated ammonia barrier catalyst”). Here, the space required for installation of the ammonia barrier catalyst is lost from the volume available for installation of the SCR catalyst.

It is possible, for example, to arrange two different catalysts in series in a converter. Such an arrangement is described in JP 2005-238195. In the embodiment disclosed there, the ammonia barrier catalyst takes up about 40% of the available space, as a result of which only about 60% of the available space is available for the SCR catalyst. US 2004/0206069 discloses a heat management method for a diesel exhaust gas purification system in goods vehicles, in which a converter for decreasing nitrogen oxides by selective catalytic reduction is a constituent of the diesel exhaust gas purification system. This converter contains not only the SCR main catalyst but also an upstream hydrolysis catalyst to liberate ammonia from urea and a downstream ammonia barrier catalyst.

In another embodiment of the “integrated ammonia barrier catalyst”, a coating containing the ammonia barrier catalyst is applied to the downstream directed part of the SCR catalyst. WO 02/100520 by the applicant describes an embodiment in which a noble metal-based oxidation catalyst is applied to an SCR catalyst present in the form of a monolithic all-active catalyst, with only 1-20% of the length of the SCR catalyst being utilized as support body for the oxidation catalyst.

In an “active” SCR system for removing nitrogen oxides from the exhaust gas of diesel engines, there is therefore firstly the problem of providing a catalyst and conditions for effective removal of nitrogen oxide by selective catalytic reduction. Secondly, incompletely reacted ammonia may not be allowed to be liberated into the environment. An exhaust gas unit which solves this problem also has to be designed so that firstly very little space is required for installation of the catalysts required but secondly the selectivity of the system to nitrogen is as high as possible.

It is an object of the present invention to provide a catalyst, an exhaust gas purification unit and/or a method by means of which nitrogen-containing pollutant gases can be removed from the completely lean exhaust gas of diesel engines by means of an “active” SCR process, regardless of whether the nitrogen is present in the pollutant gases in oxidized form, e.g. in nitrogen oxides, or in reduced form, e.g. in ammonia.

To achieve such an object, EP 0 773 057 A1 proposes a catalyst containing a zeolite exchanged with platinum and copper (Pt—Cu zeolite). In a particular embodiment, this Pt—Cu zeolite catalyst is applied to a common substrate. In addition, a second catalyst which contains a zeolite which has been exchanged only with copper is present.

According to the invention, the object is achieved by a catalyst which contains a honeycomb body and a coating composed of two superposed catalytically active layers, wherein the lower layer applied directly to the honeycomb body contains an oxidation catalyst and the upper layer applied thereto contains an ammonia storage material and has an ammonia storage capacity of at least 20 milliliters of ammonia per gram of catalyst material.

For the purposes of the present document, ammonia storage materials are compounds which contain acid sites to which ammonia can be bound. A person skilled in the art will divide these into Lewis-acid sites for the physiosorption of ammonia and Brønsted-acid sites for the chemisorption of ammonia. An ammonia storage material in an ammonia barrier catalyst according to the invention has to contain a significant proportion of Brønsted-acid sites and optionally Lewis-acid sites in order to ensure a sufficient ammonia storage capacity.

The magnitude of the ammonia storage capacity of a catalyst can be determined by means of temperature-programmed desorption. In this standard method of characterizing heterogeneous catalysts, the material to be characterized is firstly baked to remove any adsorbed components such as water and then laden with a defined amount of ammonia gas. This is carried out at room temperature. The sample is then heated at a constant heating rate under inert gas so that ammonia gas which has previously been taken up by this sample is desorbed and can be determined quantitatively by means of a suitable analytical method. An amount of ammonia in milliliters per gram of catalyst material is obtained as parameter for the ammonia storage capacity, with the term “catalyst material” always referring to the material used for characterization. This parameter is dependent on the heating rate selected. Values reported in the present document are always based on measurements at a heating rate of 4 kelvin per minute.

The catalyst of the invention is able to store at least 20 milliliters of ammonia per gram of catalyst material in the upper layer. Particular preference is given to ammonia storage materials having an ammonia storage capacity of from 40 to 70 milliliters per gram of ammonia storage material, as is typical of, for example, iron-exchanged zeolites which are preferably used. These preferred iron-exchanged zeolites not only have an optimal ammonia storage capacity but also a good SCR activity. Addition of further components such as additional SCR catalysts, nitrogen oxide storage materials or oxides which are stable at high temperatures in order to improve the thermal stability enable a very particularly preferred storage capacity of the upper layer of from 25 to 40 milliliters of ammonia per gram of catalyst material to be obtained, with the term “catalyst material” referring to the mixture of ammonia storage material and the further components.

The catalyst of the invention contains significant amounts of ammonia storage material only in the upper layer. The lower layer is free thereof. This is a substantial improvement over the solution proposed in EP 0 773 057 A1 which has Pt—Cu zeolite in the lower layer and Cu zeolite in the upper layer and therefore has ammonia storage material over the entire layer thickness of the catalyst. In such an embodiment, the total amount of ammonia storage material in the catalyst is so large that in the event of temperature fluctuations in dynamic operation there is a risk of uncontrolled desorption of ammonia and as a result increased ammonia breakthroughs surprisingly occur in dynamic operation, as experiments by the inventors show (cf. comparative example 3). In contrast thereto, the restriction of the ammonia storage material to the upper layer and simultaneous limitation of the amount to the particularly preferred values avoids “overloading” of the catalyst with ammonia and thus the uncontrolled desorption.

In its preferred embodiments, the catalyst of the invention contains an oxidation catalyst having a strong oxidizing action in the lower layer. The oxidizing catalysts typically comprise a noble metal and an oxidic support material, preferably platinum or palladium or mixtures of platinum and palladium on a support material selected from the group consisting of active aluminum oxide, zirconium oxide, titanium oxide, silicon dioxide and mixtures or mixed oxides thereof.

The catalyst of the invention can, when appropriately dimensioned, be used as SCR catalyst, which then has a reduced ammonia breakthrough compared to conventional catalysts. In addition, the catalyst of the invention is suitable as very selective ammonia barrier catalyst.

The catalyst of the invention is thus able, depending on the dimensions, firstly to reduce nitrogen oxides, (i.e. pollutant gases containing nitrogen in oxidized form) and also to eliminate ammonia (i.e. pollutant gases containing nitrogen in reduced form) by oxidation.

This multifunctionality is in detail presumably due to the following reactions, which are shown schematically in FIG. 1:
1) Nitrogen oxides and ammonia from the exhaust gas are adsorbed on the upper layer (1) which is an SCR-active coating and react in a selective catalytic reaction to form water and nitrogen which desorb after conclusion of the reaction. Here, ammonia is present in a superstoichiometric amount, i.e. is present in excess.
2) Excess ammonia diffuses into the upper layer (1). Ammonia is partly stored there.
3) Ammonia which has not been stored passes through the upper coating (1) to the layer (2) underneath which has a powerful oxidizing action. Here, nitrogen and nitrogen oxides are produced. The nitrogen formed diffuses unchanged through the upper layer (1) and goes into the atmosphere.
4) Before the nitrogen oxides formed in the lower layer (2) leave the system, they once again pass through the coating (1) located on top of the oxidation layer. Here, they are reacted with previously stored ammonia NH₃_{_{—}}_{stored} in an SCR reaction to form N₂.

If noble metal from the lower layer gets into the upper catalyst layer by means of diffusion processes, this leads to a reduction in the selectivity of the selective catalytic reduction since the reaction then no longer proceeds as a comproportionation to form nitrogen but as an oxidation to form a low-valency nitrogen oxide such as N₂O. Such noble metal diffusion processes typically take place only at elevated temperatures.

The catalyst of the invention is therefore outstandingly suitable, when appropriately dimensioned, for use as SCR catalyst having reduced ammonia breakthrough at temperatures in the range from 150° C. to 400° C., particularly preferably from 200° C. to 350° C. In exhaust gas purification units in vehicles having a diesel engine, such temperatures typically occur in converters which are located in underfloor positions at the end of the exhaust gas train. If a catalyst according to the invention having a sufficient volume is installed in such an exhaust gas unit at the end of the exhaust gas train in an underfloor converter, the nitrogen oxides produced by the diesel engine can be removed effectively with avoidance of a high secondary emission of ammonia.

In a corresponding process for decreasing the nitrogen-containing pollutant gases, ammonia or a compound which can be decomposed into ammonia is introduced into the exhaust gas train upstream of the catalyst according to the invention arranged in the underfloor position. Use of an additional ammonia barrier catalyst can generally be dispensed with in such a process.

The catalyst of the invention can also be used in combination with a conventional SCR catalyst as extremely effective ammonia barrier catalyst. Here, preference is given to using SCR catalysts which contain a zeolite exchanged with copper or iron or a zeolite exchanged with copper and iron or mixtures thereof. Furthermore, it is possible to use SCR catalysts which contain vanadium oxide or tungsten oxide or molybdenum oxide on a support material comprising titanium oxide. Various embodiments of the exhaust gas unit are conceivable.

Thus, SCR catalyst and ammonia barrier catalyst of the invention can in each case be present in the form of a coating on an inert honeycomb body, with both honeycomb bodies comprising an inert material, preferably ceramic or metal. The two honeycomb bodies can be present in two converters connected in series or in a common converter, with the ammonia barrier catalyst always being arranged downstream of the SCR catalyst. When the catalysts are arranged in one converter, the volume of the ammonia barrier catalyst typically makes up 5-40% of the space available in the converter. The remaining volume is occupied by the SCR catalyst or by the SCR catalyst and a hydrolysis catalyst which may be present at the inflow end. Furthermore, an oxidation catalyst which serves to oxidize nitrogen monoxide to nitrogen dioxide can be arranged upstream of the SCR catalyst.

In a preferred embodiment of the exhaust gas unit, the two honeycombs of the SCR catalyst and of the catalyst of the invention used as ammonia barrier catalyst form one unit having a front part and a back part. The oxidation catalyst which represents the lower layer of the ammonia barrier catalyst of the invention is located only on the back part of the honeycomb body. The upper layer of the ammonia barrier catalyst of the invention is designed as SCR catalyst. It can have been deposited over the entire length of the honeycomb body, in which case it covers the coating containing the oxidation catalyst.

In another embodiment of the exhaust gas unit of the invention, the SCR catalyst can be in the form of a honeycomb body which consists entirely of the SCR-active material (known as all-active extruded SCR catalyst). The ammonia barrier catalyst of the invention is then applied as a coating to the back part of this all-active extruded catalyst, so that the back part of the SCR catalyst serves as support body for the ammonia barrier catalyst.

The invention is illustrated below with the aid of comparative examples and examples and FIGS. 1 to 7.

FIG. 1: Functional principle of the catalyst of the invention for removing nitrogen-containing pollutant gases from the exhaust gas of diesel engines, which comprises a honeycomb body and at least two superposed, catalytically active layers.

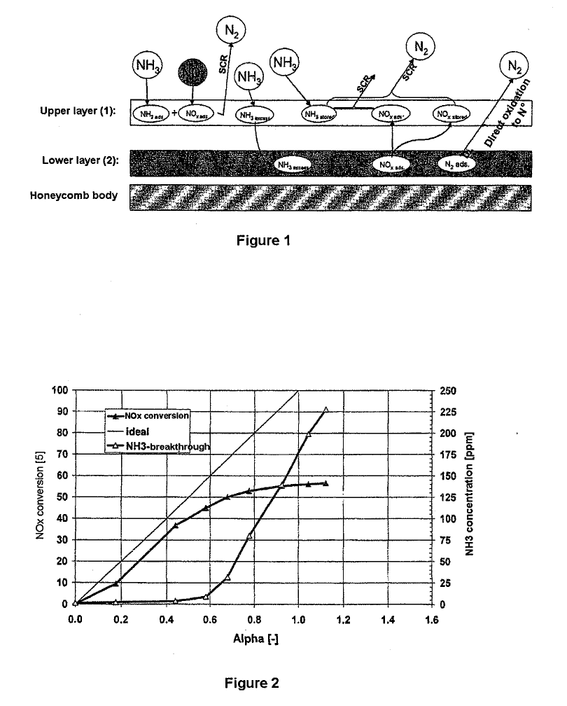

FIG. 2: Improvement of the nitrogen oxide conversion of a conventional SCR catalyst by increasing the alpha value

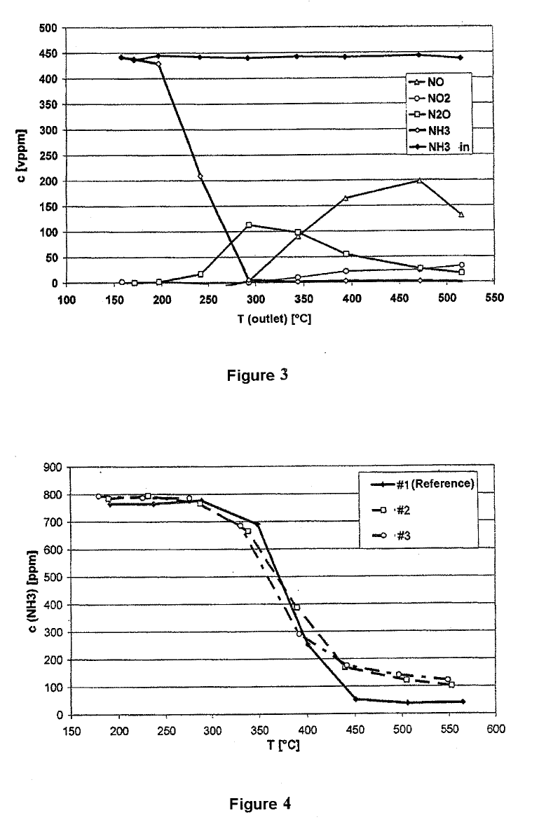

FIG. 3: Concentrations of the nitrogen compounds formed in the oxidation of ammonia over an exhaust gas purification system comprising a conventional SCR catalyst and an unselective ammonia oxidation catalyst as a function of temperature

FIG. 4: Effectiveness of the oxidation of ammonia over catalysts according to the invention (#2 and #3) compared to a reference oxidation catalyst (#1)

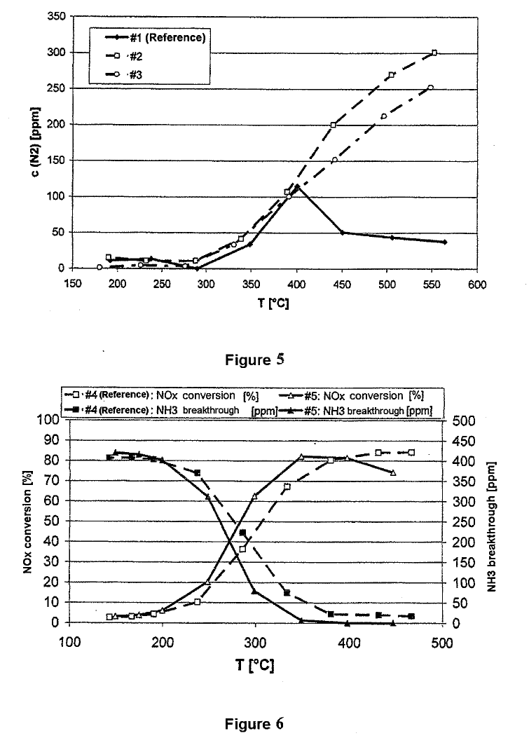

FIG. 5: Temperature-dependence of the selectivity of the oxidation of ammonia to N₂ of catalysts according to the invention (#2 and #3) compared to a reference oxidation catalyst (#1)

FIG. 6: Nitrogen oxide conversion and NH₃ breakthrough of a catalyst according to the invention (#5) and a conventional SCR catalyst containing iron-exchanged zeolites (#4), after hydrothermal ageing at 650° C.

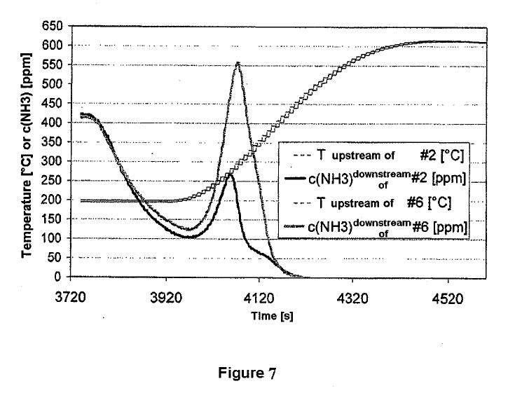

FIG. 7: NH₃ desorption measured over a catalyst according to the invention laden at 200° C. with a starting concentration of 450 ppm of NH₃ (#2) and a correspondingly pretreated catalyst as per EP 0 773 057 A1 (#6)

### COMPARATIVE EXAMPLE 1

In this comparative example, the improvement in the nitrogen oxide conversion over a conventional SCR catalyst as a result of an increase in the molar ratio alpha was examined. Here, the increase in the ammonia concentration necessary for increasing the alpha value was effected by introduction of excess urea. The SCR catalyst contained a coating of iron-exchanged zeolites on a ceramic honeycomb body. The volume of the honeycomb body was 12.5 l. It had 62 cells/cm² at a thickness of the cell walls of 0.17 mm.

The measurement of the nitrogen oxide conversion was carried out on an engine test bed provided with a 6.4 l, 6 cylinder Euro3 engine. 6 different exhaust gas temperatures (450° C., 400° C., 350° C., 300° C., 250° C., 200° C.) were generated in succession by means of stationary engine points. At each constant engine point, the urea addition was increased stepwise and the molar ratio α was thus varied. As soon as the gas concentrations at the outlet from the catalyst were stable, the nitrogen oxide conversion and the ammonia concentration downstream of the catalyst were recorded. As an example, FIG. 2 shows the result for an exhaust gas temperature upstream of the catalyst of 250° C.

Under the assumption that the ammonia breakthrough should not be above 10 ppm, a nitrogen oxide conversion of about 45% can be achieved in the example shown. However, the conversion curve indicates that a nitrogen oxide conversion of up to 57% would be able to be achieved at a higher alpha value. In the case of the system examined (only conventional SCR catalyst), this is associated with a considerable ammonia breakthrough (225 ppm). To minimize the ammonia breakthroughs, either a catalyst according to the invention should be used as SCR catalyst instead of the conventional SCR catalyst or the system should be supplemented by a suitable ammonia barrier catalyst.

### COMPARATIVE EXAMPLE 2

In this example, two catalysts connected in series were examined in a model gas unit. The two catalysts had the following composition and were applied as coating to ceramic honeycomb bodies having a cell density of 62 cm⁻²:
1st catalyst: Conventional SCR catalyst based on V₂O₅/TiO₂;
   Dimensions of the honeycomb body: 25.4 mm diameter, 76.2 mm length
2nd catalyst: Conventional ammonia barrier catalyst comprising 0.353 g/l of Pt (=10 g/ft³ Pt) and a mixed oxide comprising predominantly titanium dioxide;
   Dimensions of the honeycomb body: 25.4 mm diameter, 25.4 mm length

Nine different stationary temperature points were set in succession on the model gas unit. The concentrations of the nitrogen components NH₃, N₂O, NO and NO₂ obtained at the outlet from the system were measured as a function of temperature using an FTIR spectrometer. The model gas had the following composition:

| Gas component | Concentration |
|---|---|
| Nitrogen oxide NOₓ | 0 vppm |
| Ammonia | 450 vppm |
| Oxygen | 5% by volume |
| Water | 1.3% by volume |
| Nitrogen | Balance |
| Space velocity over the | 30 000 h⁻¹ |
| total catalyst system: | |
| Space velocity over the | 120 000 h⁻¹ |
| ammonia barrier catalyst: | |
| Gas temperature (inlet) | 550; 500; 400; 350; 300; |
| | 250; 200; 175; 150 |

The concentrations of the nitrogen components measured are shown in graph form as a function of temperature in FIG. 3. At temperatures above 200° C., ammonia is removed effectively from the exhaust gas mixture. However, at higher temperatures (T≧300° C.), the formation of undesirable by-products was observed. As the temperature increases, there is increased formation of nitrogen components having a higher oxidation state, from +I(N₂O) through +II(NO) to +IV(NO₂).

### EXAMPLE 1

The overoxidation to nitrogen oxides observed in comparative example 2 can be greatly reduced by use of a catalyst according to the invention as ammonia barrier catalyst while maintaining the same oxidizing power. The following table shows the formulations according to the invention which were tested by way of example as ammonia barrier catalysts.

| | | Noble metal |
|---|---|---|
| Catalyst | Description | content |
| #1 | Reference: | 0.353 g/l |
| | Unselective NH₃ oxidation | |
| | catalyst comprising platinum on | |
| | a mixed oxide containing | |
| | predominantly aluminum oxide | |
| #2 | Upper layer (1): SCR catalyst | 0.353 g/l |
| | based on an iron-exchanged | |
| | zeolite having an NH₃ storage | |
| | capacity of 58 ml/g of catalyst | |
| | material | |
| | Lower layer (2): Unselective | |
| | NH₃ oxidation catalyst like #1 | |
| #3 | Upper layer (1): SCR catalyst | 0.353 g/l |
| | based on an iron-exchanged | |
| | zeolite with addition of a | |
| | barium-based nitrogen storage | |
| | component; the NH₃ storage | |
| | capacity of the layer is | |
| | 29 ml/g of catalyst material | |
| | Lower layer (2): Unselective | |
| | NH₃ oxidation catalyst like #1 | |

NH₃ conversion activity and selectivity to nitrogen were tested on the model gas unit using the following gas composition:

| Gas component | Concentration |
|---|---|
| Nitrogen oxide NOₓ | 0 vppm |
| Ammonia | 800 vppm |
| Propene C₃H₆ | 40 vppm |
| CO₂ | 8% by volume |
| Oxygen | 5% by volume |
| Water | 1.3% by volume |
| Nitrogen | Balance |
| Space velocity | 320 000 h⁻¹ |
| Gas temperature | 550; 500; 450; 400; 350; 300; |
| | 250; 200 |

Compared to comparative example 2, higher space velocities were selected. This corresponds to the requirement that the volume of the ammonia barrier catalyst should be kept as small as possible. The ammonia concentrations selected are higher than customary in practical use and in combination with the lower noble metal content should ensure better differentiability of the results.

FIG. 4 shows the effectiveness of the oxidation of ammonia: The curve of ammonia concentration downstream of the catalyst as a function of the temperature clearly shows that the ammonia light-off temperatures T₅₀ (NH₃) for the two catalysts #2 and #3 according to the invention are in the same region (370° C. to 390° C.) as the ammonia light-off temperatures of the unselective reference NH₃ oxidation catalyst (about 380° C.). The oxidation activity of all samples tested is equivalent. Despite the high space velocities, the NH₃ light-off behavior is not influenced by the upper layer. The residual NH₃ concentration of about 100 ppm at 550° C. which is observed can be attributed to diffusion limitation due to the very high space velocity over the catalyst selected in this experiment.

The selectivity to N₂ can be calculated from the difference between all nitrogen components measured and the amount of ammonia introduced. It is shown as a function of temperature in FIG. 5.

If the temperature exceeds 400° C., nitrogen oxides are formed as by-products over the reference catalyst. The N₂ formation is in this way reversed at increasing temperatures. In contrast thereto, all two-layer catalysts according to the invention (#2, #3) display a significantly improved selectivity to N₂.

### EXAMPLE 2

The ammonia breakthrough observed in comparative example 1 can be reduced by use of a catalyst according to the invention as SCR catalyst. Comparison of NOₓ conversion and ammonia breakthrough concentration of a conventional SCR catalyst containing iron-exchanged zeolites with a catalyst according to the invention demonstrates this. The following catalysts were examined:
#4: Conventional SCR catalyst based on an iron-exchanged zeolite, as in comparative example 1;
   Dimensions of the honeycomb body: 25.4 mm diameter, 76.2 mm length
#5: Catalyst according to the invention;
   Lower layer containing 0.0353 g/l of Pd (=1 g/ft³ Pd) supported on zirconium oxide and aluminum oxide;
   Upper layer: SCR catalyst based on an iron-exchanged zeolite having an NH₃ storage capacity of 58 ml/g of catalyst material;
   Dimensions of the honeycomb body: 25.4 mm diameter, 76.2 mm length

Both catalysts were firstly subjected to a synthetic hydrothermal ageing in an atmosphere of 10% by volume of oxygen and 10% by volume of water vapor in nitrogen at 650° C. in a furnace. The SCR conversion activity and ammonia concentration downstream of the catalyst were subsequently tested in a model gas unit under the following conditions:

| Gas component | Concentration |
|---|---|
| Nitrogen oxide NO: | 500 vppm |
| Ammonia NH₃: | 450 vppm |
| Oxygen O₂: | 5% by volume |
| Water H₂O: | 1.3% by volume |
| Nitrogen N₂: | Balance |
| Space velocity | 30 000 h⁻¹ |
| Gas temperature [° C.] | 450; 400; 350; 300; 250; |
| | 200; 175; 150 |

The results of the study are shown in FIG. 6. It is clear that the catalyst according to the invention #5 displays both an improved nitrogen oxide conversion and a reduced NH₃ breakthrough compared to the conventional, iron-zeolite-based SCR catalyst #4 after hydrothermal ageing in the temperature range 200-350° C.

### COMPARATIVE EXAMPLE 3

A catalyst as described in EP 0 773 057 A1 was produced. For this purpose, 35 g/l of a coating comprising 1% by weight of platinum and a copper-exchanged ZSM-5 zeolite (SiO₂:Al₂O₃ ratio of 45) containing 2.4% by weight of copper was firstly applied to a ceramic honeycomb body having 62 cells/cm² and a cell wall thickness of 0.17 mm. After drying and calcination of the lower layer, an upper layer comprising 160 g/l of the copper-exchanged ZSM-5 zeolite (SiO₂:Al₂O₃ ratio of 45) containing 2.4% by weight of copper was applied. This was followed by renewed drying and calcination. The honeycomb body provided for testing had a diameter of 25.4 mm and a length of 76.2 mm and contained a total of 0.353 g/l of platinum, based on the volume of the honeycomb body.

The resulting catalyst #6 was examined in comparison with the catalyst according to the invention #2 from example 1 (upper layer: 160 g/l) in an ammonia desorption experiment in the model gas unit. For this purpose, the catalysts in the freshly produced state were firstly exposed to a gas mixture containing 450 ppm of ammonia at a space velocity of 30 000 l/h at 200° C. for a period of about one hour. The gas mixture additionally contained 5% by volume of oxygen and 1.3% by volume of water vapor in nitrogen. At the end of the loading time, complete breakthrough of the introduced amount of ammonia through the catalyst was observed. The introduction of ammonia was stopped.

The catalysts were, after a hold time of two minutes at constant temperature, heated at a heating rate of 1° per second. The amount of ammonia desorbed was measured by means of an FTIR spectrometer.

FIG. 7 shows the results obtained for the catalyst according to the invention #2 and the comparative catalyst as per EP 0 773 057 A1, #6. Apart from the ammonia concentrations measured downstream of the catalyst, the temperatures measured upstream of the catalyst over the course of the experiments are plotted. Only the desorption phase is shown.

In the case of both catalysts, ammonia desorption commences at about 210° C. It can clearly be seen that considerably more ammonia is desorbed from the comparative catalyst #6 than from the catalyst according to the invention #2. This “overloading” of the catalyst #6 with ammonia leads, as described above, to uncontrolled ammonia desorption in the event of temperature fluctuations in dynamic operation and thus to undesirable ammonia breakthroughs during driving of the vehicle.

1. A catalyst for removing nitrogen-containing pollutant gases from the exhaust gas of diesel engines, which contains a honeycomb body and a coating composed of two superposed catalytically active layers,
wherein the lower layer applied directly to the honeycomb body contains an oxidation catalyst and
the upper layer applied thereto contains one or more iron-exchanged zeolites, which have also a good SCR activity, as ammonia storage material, which has an ammonia storage capacity of at least 20 milliliters of ammonia per gram of catalyst material.

2. (canceled)

3. The catalyst as claimed in claim 1, wherein the lower layer is free of ammonia storage materials.

4. The catalyst as claimed in claim 3, wherein the oxidation catalyst present in the lower layer contains platinum or palladium or mixtures of platinum and palladium on a support material selected from the group consisting of active aluminum oxide, zirconium oxide, titanium oxide, silicon dioxide and mixtures or mixed oxides thereof.

5. An exhaust gas purification unit for removing nitrogen-containing pollutant gases from the exhaust gas of diesel engines, which contains an SCR catalyst and an ammonia barrier catalyst, characterized in that the ammonia barrier catalyst contains a honeycomb body and a coating comprising two superposed catalytically active layers, wherein the lower layer applied directly to the honeycomb body contains an oxidation catalyst and
the upper layer applied thereto contains one or more iron-exchanged zeolites, which have also a good SCR activity, as ammonia storage material, which has an ammonia storage capacity of at least 20 milliliters of ammonia per gram of catalyst material.

6. The exhaust gas purification unit as claimed in claim 5, wherein the SCR catalyst is also present in the form of a coating on a honeycomb body and both honeycomb bodies comprise an inert material selected from among ceramic and metal.

7. The exhaust gas purification unit as claimed in claim 6, wherein the two honeycomb bodies form one unit having a front part and a back part and the oxidation catalyst is located on the back part of the honeycomb body.

8. The exhaust gas purification unit as claimed in claim 7, wherein the two honeycomb bodies form one unit having a front part and a back part and the oxidation catalyst is located on the back part of the honeycomb body while the SCR catalyst is deposited over the entire length of the honeycomb body and covers the oxidation catalyst on the back part of the honeycomb body.

9. The exhaust gas purification unit as claimed in claim 5, wherein the SCR catalyst is in the form of a honeycomb body which consists entirely of the SCR catalyst.

10. The exhaust gas purification unit as claimed in claim 9, wherein a back part of the SCR catalyst serves as supporter body for the ammonia barrier catalyst.

11. The exhaust gas purification unit as claimed in claim 5, wherein a further oxidation catalyst for the oxidation of nitrogen monoxide to nitrogen dioxide is arranged upstream of the SCR catalyst.

12. The exhaust gas purification unit as claimed in claim 5, wherein the SCR catalyst contains a zeolite which has been exchanged with copper or iron or a zeolite which has been exchanged with copper and iron or mixtures thereof.

13. The exhaust gas purification unit as claimed in claim 5, wherein the SCR catalyst contains vanadium oxide or tungsten oxide or molybdenum oxide on a support material comprising titanium oxide.

14. An exhaust gas purification unit for removing nitrogen-containing pollutant gases from the exhaust gas of diesel engines, which contains an SCR catalyst, wherein
the SCR catalyst contains a honeycomb body and a coating comprising two superposed catalytically active layers, wherein the lower layer applied directly to the honeycomb body contains an oxidation catalyst and
the upper layer applied thereto contains one or more iron-exchanged zeolites, which have also a good SCR activity, as ammonia storage material, which has an ammonia storage capacity of at least 20 milliliters of ammonia per gram of catalyst material.

15. A process for decreasing nitrogen-containing pollutant gases in the exhaust gas of diesel engines, wherein an exhaust gas purification unit having a converter containing a catalyst as claimed claim 1 located in an underfloor position is used.

16. The process as claimed in claim 15, wherein ammonia or a compound which can be decomposed into ammonia is introduced into the exhaust gas stream upstream of the catalyst.

17. The process as claimed in claim 15, wherein the temperature in the catalyst is in the range from 150° C. to 400° C.

18. The process as claimed in claim 15, wherein no additional ammonia barrier catalyst is used downstream of the catalyst.
